(19) United States
(12) Patent Application Publication
(10) Pub. No.: US 2006/0239152 A1
(43) Pub. Date: Oct. 26, 2006

(54) Disc recording methods and systems

(75) Inventors: Pin-Chou Liu, Banchiau City (TW); Juan-Huei Chen, Sanchung City (TW); Sung-Yang Wu, Daya Hsiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/113,577

(22) Filed: Apr. 25, 2005

(51) Int. Cl. G11B 20/10

(52) U.S. Cl. 369/47.33

(57) ABSTRACT

Encoded data is produced then buffered in a memory buffer for recording on a disc, and data production is paused to prevent buffer overflow if the memory buffer is full. The data is recorded according to a write command, and the host may retry for a limited period or number of times if recording fails. A current recording area on the disc is determined as defective if a number of retries exceeds the limit or if the write command fails, and is skipped by searching for a writable address. The buffered data is thereafter recorded from the writable address. The buffered data is dropped if necessary when the write command fails.

### BACKGROUND

The invention relates to disc recording, and more specifically, to disc recording methods and systems capable of handling errors in real-time data recording.

Data recording devices of many types, capable of recording data on various types of storage media are currently available, such as hard disks for use in personal computers, and optical discs recording for digital information. Digital information such as video and audio signals can be recreated with substantially the same quality as when recorded on an optical disc, even when the recordings are edited and copied repeatedly. The digital information is successively recorded in tracks previously formed on the optical disc in a spiral or concentric fashion. In this specification, “optical discs” refer to various types of discs, such as phase change discs (CD-RW, DVD+RW, DVD-RW, DVD-RAM, Blu-ray discs), magneto-optical discs (MO, MD), dye-containing discs (CD-R, DVD+R, DVD-R), and preformatted discs (CD-ROM, DVD-ROM). During real-time recording, the host may encounter various faults, such as command errors, command timeouts, tracking errors, and buffer under-runs, causing errors in the recording process. The recording process may also be interrupted if a scratch or a defective area exists on the disc surface.

Conventionally, the recording process simply stops when an error is detected, rendering the entire capacity of the disc useless. In U.S. Pat. No. 6,058,085, Obata discloses a disc recording method and apparatus thereof for identifying and skipping defective sections on the disc, the method comprises determining whether the section of the disc being recorded is defective, stopping the recording in case of a determined defect, and restarting the recording from a beginning of a section immediately subsequent to the defective section on the disc. This method is however not appropriate for real-time recording since data is generated continuously. A buffer over-run problem occurs if the host buffering time is shorter than the error recovering time, and data may be disordered. Furthermore, recording the data of the defective block may violate some real-time recording specifications.

### SUMMARY

Disc recording methods and systems with error handling mechanism are provided. Some embodiments of the disc recording system comprise an encoder, a memory buffer, a burning engine, and a loader. The encoder encodes data for recording on a disc, and the memory buffer coupled to the encoder stores the encoded data. The burning engine checks a status of the memory buffer, and pauses the encoder for data encoding to prevent buffer overflow if the memory buffer is full. The burning engine sends a predetermined size of the buffered data with a write command to the loader. The loader records the buffered data on the disc while receiving the data with the write command, and notifies the burning engine if recording is successful. The burning engine finds a writable address for skipping a current recording area on the disc if the write command fails, and drops the buffered data if necessary.

In an embodiment, the burning engine requests the loader to retry recording of the buffered data on the disc if the write command fails until reaching a retry limit, and the burning engine starts finding the writable address only when the retry limit is reached. In another embodiment, the burning engine checks an error-handling configuration to determine whether to request the loader to retry recording or find the writable address directly, where the error-handling configuration is customized.

Some embodiments of the disc recording method comprise producing and buffering the data in a memory buffer, and pausing data production to prevent buffer overflow if the memory buffer is full. The buffered data is recorded on a disc according to a write command. A current recording area on the disc is determined as defective when the write command fails, and is skipped by searching a writable address and recording the buffered data from the writable address. The buffered data is dropped when the write command fails if the buffered data cannot be recorded in discrete logical addresses.

In some embodiments, the failure of the write command may not be caused by a defective area, thus the recording process retries recording of the buffered data on the disc for a predetermined period or number of times. If the write command succeeds before reaching the predetermined period or number of times, the recording process for the buffered data is complete, otherwise it finds the writable address.

### DESCRIPTION OF THE DRAWINGS

The invention can be more fully understood by reading the subsequent detailed description in conjunction with the examples and references made to the accompanying drawings, wherein:

FIG. 1 shows an embodiment of a disc recording system.

FIG. 2 is a flowchart illustrating an exemplary recording method with error handling.

### DETAILED DESCRIPTION

Disc recording methods and systems capable of handling errors in real-time data recording are provided. Embodiments of the disc recording methods and systems prevent buffer overflow, drop recording data as little as possible, and make playback smooth. The recording is made flexible when a defective area is located, since the system is capable of retrying or skipping the defective area by finding a writable address anywhere on the entire disc.

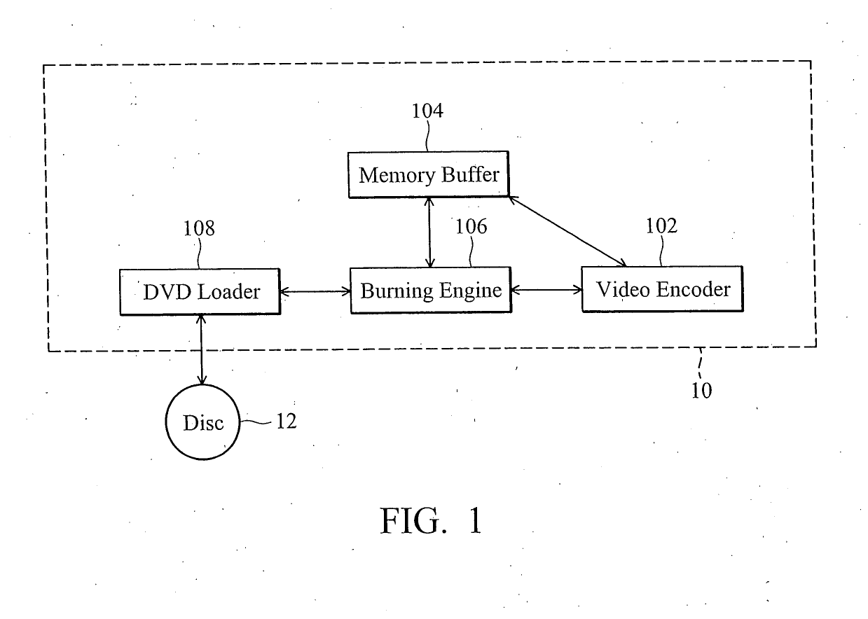

FIG. 1 shows an embodiment of the disc recording system 10 recording data a disc 12. The disc recording system 10 comprises a video encoder 102, a memory buffer 104, a burning engine 106, and a DVD loader 108. The video encoder 102 encodes video and/or audio data into packet data of a specific format when receiving a start recording command. The video encoder 102 stores the packet data into the memory buffer 104 and notifies the burning engine 106 that there is data stored therein for recording on the disc 12. Under normal recording conditions with no errors, the burning engine 106 acquires the packet data from the memory buffer 104 and sends the packet data with a write command to the DVD loader 108. The DVD loader 108 then receives the write command and starts storing the packet data in its write buffer. The DVD loader 108 starts writing the packet data to the disc 12 when the data size in the write buffer reaches a threshold.

In some embodiments, the burning engine 106 monitors the write buffer of the DVD loader 108 by querying if there is enough space in the write buffer. The burning engine 106 sends the packet data and the write command to the DVD loader 108 only when the write buffer still has capacity.

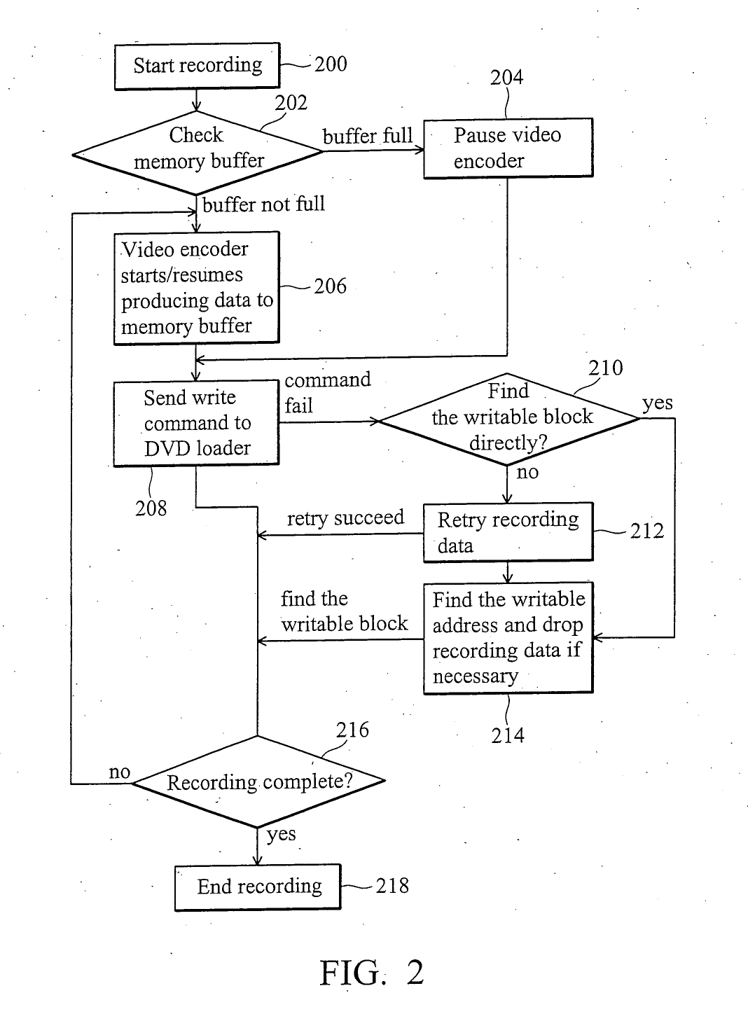

FIG. 2 is a flowchart showing an embodiment of a disc recording method capable of handling various error types. When a start recording command is sent from a user interface (UI), a video encoder starts producing data for recording (Step 200). The video encoder stores the generated data in a memory buffer, and the capacity of the memory buffer will be checked (Step 202). The video encoder continuously produces data for recording and stores the data in the memory buffer if the memory buffer has sufficient buffer capacity (Step 206). In some circumstances the data consumption rate is lower than the data production rate, for example, when a write command is delayed by the retry recording process, or when a write command is timed out. As a result, the memory buffer is full, and the video encoding will be paused to prevent buffer overflow (Step 204).

The data in the memory buffer and a write command are sent to a DVD loader (Step 208), and the DVD loader records the data to a disc regardless of whether the video encoder is producing data or currently paused. The host treats the data as recorded successfully if the DVD loader returns a successful status message within a predetermined timeout period, and the recording flow enters Step 216 to determine if the recording is complete. If the recording process is not yet complete, the recording flow returns to Step 202 to determine the status of the memory buffer again, otherwise the recording flow is finished at Step 218.

The recording process enters an error handling flow if the write command fails at Step 208. An error-handling configuration is first checked at Step 210, which can be customized. The recording flow goes to Step 214 if the error-handling configuration is set to find the writable address directly; otherwise, the recording flow goes to Step 212 for retrying the write command. The default configuration is typically set to retry recording the data because the failure of the write command is not always caused by a defective area on the disc. If the write command fails again, it continuously retries recording until reaching a retry limit, for example, a predetermined period or number of times. The recording flow enters Step 216 if the write command succeeds before the retry limit is reached; otherwise the host attempts to find the writable address at Step 214.

There are several ways to locate the writable address. In an embodiment, the host tries to record the data at a subsequent address following the previous failed address, and if the write command fails again, the host tries the next address until a write command succeeds. The recording flow will therefore continue writing the buffered data from this address. Note that in some embodiments of disc recording systems and methods, the writable address does not necessarily have to be an address following the failed address, it may be also an address preceding to the failed address. In another embodiment, the host (back-end) sends a special command to a front-end device, such as the DVD loader, and requests that the front-end device to find the writable address. The front-end device may search the writable address by detecting a wobble signal, and the front-end device stays focused on the track. A writable address is determined if the wobble signal is recognizable. The front-end device may also reference on other signals processed from reflected laser signals to decide if the address is writable. For severely a damaged disc, the front-end device may not keep tracking on the track, and the optical pick-up head will jump out to search for readable wobble signal on the track. In another embodiment, writable addresses are collected in a table before recording, thus one of the writable addresses can be selected from the table when needed. After finding the writable address, the recording flow continues from this writable address, and proceeds verification in Step 216 after recording the data on the disc. The recording process is terminated in Step 218 if the answer to Step 216 is true.

In some real-time recording specifications, continuous data is not allowed to be recorded in discrete logical addresses, thus the data will be dropped in Step 214 if retry failures exceed the retry limit or when the recording flow is trying to find a writable address for recording. The host may also drop the associated data of the skipped area in the buffer to conform the real-time recording format.

Embodiments of the proposed disc recording methods and systems provide continuous recording for real-time applications, and the error handling mechanism prevents buffer overflow, minimizes the data drop rate during recording, and makes the playback smooth.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A disc recording system, comprising
an encoder, encoding data for recording on a disc;
a memory buffer, storing the data encoded by the encoder;
a burning engine, pausing the encoder for data encoding to prevent buffer overflow if the memory buffer is full, retrieving the data from the memory buffer, sending a predetermined size of the data with a write command for recording, finding a writable address for skipping a current recording area on the disc if the write command fails, and dropping the data if necessary; and
a loader, receiving the data and the write command from the burning engine, recording the data on the disc, and notifying the burning engine if recording is successful.

2. The disc recording system according to claim 1, wherein the burning engine requests the loader to retry recording the data on the disc if the write command fails until reaching a retry limit, and the burning engine begins locating the writable address when the retry limit is reached.

3. The disc recording system according to claim 2, wherein the retry limit is defined by a predetermined period or a predetermined number of times for retrying.

4. The disc recording system according to claim 2, wherein the burning engine checks an error-handling configuration to determine whether to request the loader to retry recording or find the writable address directly.

5. The disc recording system according to claim 2, wherein the memory buffer is full when the write command is timed out or delayed by retrying recording.

6. The disc recording system according to claim 1, wherein the burning engine drops the data that cannot be recorded according to discrete logical addresses when the write command fails.

7. The disc recording system according to claim 1, wherein the burning engine drops the data corresponding to the current recording area when the writable address is found and the current recording area is skipped.

8. The disc recording system according to claim 1, wherein the burning engine determines the write command as failed if a successful notification is not received from the loader within a predetermined timeout period.

9. The disc recording system according to claim 1, wherein the burning engine finds the writable address by trying a subsequent address of the previous failed-address until a write command succeeds.

10. The disc recording system according to claim 1, wherein the burning engine finds the writable address by sending a special command to the loader, and the loader searches and returns the writable address to the burning engine after receiving the special command.

11. The disc recording system according to claim 10, wherein the loader searches for the writable address by detecting a wobble signal.

12. The disc recording system according to claim 10, wherein the loader searches for the writable address by detecting a signal processed from a reflected laser signal.

13. The disc recording system according to claim 1, wherein the burning engine collects a plurality of writable addresses in a table before recording, and finds the writable address by searching the table.

14. The disc recording system according to claim 1, wherein the loader comprises a write buffer for storing the data received from burning engine, and the burning engine monitors the write buffer and sends the data with the write command to the loader if the write buffer is not full.

15. The disc recording system according to claim 14, wherein the loader starts recording the data on the disc when the amount of data in the write buffer reaches a threshold.

16. A disc recording method, comprising:
producing data and buffering the data in a memory buffer for recording;
pausing data production to prevent buffer overflow if the memory buffer is full;
sending a predetermined size of the data with a write command for recording;
recording the data on a disc when receiving the write command;
finding a writable address for skipping a current recording area on the disc if the write command fails; and
dropping the buffered data if necessary.

17. The disc recording method according to claim 16, further comprising retrying recording of the data on the disc if the write command fails until reaching a retry limit, and finding the writable address when the retry limit is reached.

18. The disc recording method according to claim 17, wherein the retry limit is defined by a predetermined period or a predetermined number of retry times.

19. The disc recording method according to claim 17, further comprising checking an error-handling configuration to determine whether to retry recording or find the writable address directly.

20. The disc recording method according to claim 17, wherein the memory buffer is full when the write command is timed out or delayed due to retrying recording.

21. The disc recording method according to claim 16, wherein the dropped data comprises the buffered data that cannot be recorded in discrete logical addresses.

22. The disc recording method according to claim 16, wherein the dropped data comprises the data corresponding to the current recording area when the writable address is located and the current recording area is skipped.

23. The disc recording method according to claim 16, further comprising determining the write command to be failed if a successful notification indicating the data has been recorded successfully has not been received within a predetermined timeout period.

24. The disc recording method according to claim 16, further comprising finding the writable address by trying a subsequent address of the previous failed address until a write command succeeds.

25. The disc recording method according to claim 16, further comprising finding the writable address by sending a special command to request a loader to search and return the writable address.

26. The disc recording method according to claim 25, further comprising searching for the writable address by detecting a wobble signal.

27. The disc recording method according to claim 25, further comprising searching for the writable address by detecting a signal processed from a reflected laser signal.

28. The disc recording method according to claim 16, further comprising collecting a plurality of writable addresses in a table before recording, and the writable address is located by searching the table.

29. The disc recording method according to claim 16, further comprising buffering the data before recording on the disc, and beginning recording when the amount of buffered data reaches a threshold.
